(19) United States
(12) Patent Application Publication
(10) Pub. No.: US 2008/0172146 A1
(43) Pub. Date: Jul. 17, 2008

(54) Robot platform provided with changeable/expandable module

(76) Inventor: Chen-Wei Lin, Taipei City (TW)

Correspondence Address: PRO-TECHTOR INTERNATIONAL SERVICES, 20775 NORADA CT., SARATOGA, CA, 95070, US

(21) Appl. No.: 11/652,885

(22) Filed: Jan. 12, 2007

(51) Int. Cl. G05D 3/00; G06F 19/00

(52) U.S. Cl. 700/245; 700/264; 701/22; 901/1

(57) ABSTRACT

The present invention relates to a robot platform provided with a changeable/expandable module, which comprises a base provided in the interior thereof with a power source, a drive mechanism, a plurality of wheels, and a control unit for receiving and executing commands. The base can be controlled by the control unit to move on a plain surface in a predetermined motion mode. Besides, a chamber is also disposed in the base for receiving a module, and includes a plurality of conducting points therein for the electricity conduction of the module having processing and main controlling units, thereby changing the module on the base depended on the user's demand, transmitting the instruction of the main controlling unit to the control unit of the base so as to control the base's movement, and cooperating with the processing unit of the module to execute command.

### BACKGROUND OF THE INVENTION

1. Field of the Invention

The present invention relates to a robot platform provided with a changeable/expandable module that can change its module based on the user's demand, and can cooperate with the instruction of module to execute command.

2. Description of the Prior Arts

With modern technology development, many conventional manual labor jobs have been done by automatic mechanical equipments, such as a robot with explosion proof detecting device, a mobile detection device or a mobile vacuum cleaner and the like, so as to achieve a quicker, more efficient and safer purpose. Taking the mobile vacuum cleaner for example, it includes a movable base having a power source, a drive mechanism, a plurality of wheels, a vacuum module, as well as a control unit. The vacuum module is comprised of a rolling brush, a dust collection mechanism and an exhaust fan for executing a vacuuming job. The control unit serves to receive instructions from a control panel or a wireless device so as to command the drive mechanism and the vacuum module to execute its instruction. Since a control program has been predetermined in the control unit, it can control the drive mechanism to move on a plain surface by using a predetermined motion mode which includes an avoidable motion resulting from suffering an obstacle, forward movement in a predetermined line, or another avoidable motion resulting form a false step detection and so on. Thereafter, by means of the module, the mobile vacuuming job can be exactly executed. However, such a mobile device can only execute an individual vacuuming job instead of use in different jobs. Likewise, afore-mentioned detection device is mounted onto a mobile mechanical platform for executing an individual detection job, thus improving such modules for use in different jobs is inevitable.

The present invention has arisen to mitigate and/or obviate the afore-described disadvantages.

### SUMMARY OF THE INVENTION

The primary objective of the present invention is to provide a robot platform provided with a changeable/expandable module, which comprises a base provided in the interior thereof with a power source, a drive mechanism, a plurality of wheels, and a control unit for receiving and executing commands. The base can be controlled by the control unit to move on a plain surface in a predetermined motion mode. Besides, a chamber is also formed in the base for receiving a module, and includes a plurality of conducting points therein for the electricity conduction of the module having processing and main controlling units, thereby changing the module on the base depended on the user's demand to execute command.

Another objective of the present invention is to provide a robot platform provided with a changeable/expandable module, wherein the module in the base includes the main controlling unit and the processing unit. The main controlling unit is applied to receive the instruction from a control panel or a wireless device, and to command the control unit of the base to actuate the base's movement, simultaneously, the main controlling unit controls the control unit of the base to execute its instruction, such that the base can cooperate with the processing unit to cause a requested motion.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of a robot platform of the present invention;

FIG. 2 is a perspective view of the robot platform of the present invention;

FIG. 3 shows an exploded view of the robot platform provided with a module in accordance with a first embodiment of the present invention;

FIG. 4 shows a respective view of the robot platform provided with the module in accordance with the first embodiment of the present invention;

FIG. 5 shows an operational view of the robot platform provided with the module in accordance with the first embodiment of the present invention;

FIG. 6 is an exploded view of the robot platform provided with another module in accordance with a second embodiment of the present invention;

FIG. 7 is a perspective view of the robot platform provided with the module in accordance with the second embodiment of the present invention.

### DETAILED DESCRIPTION OF THE PREFERRED EMBODIMENT

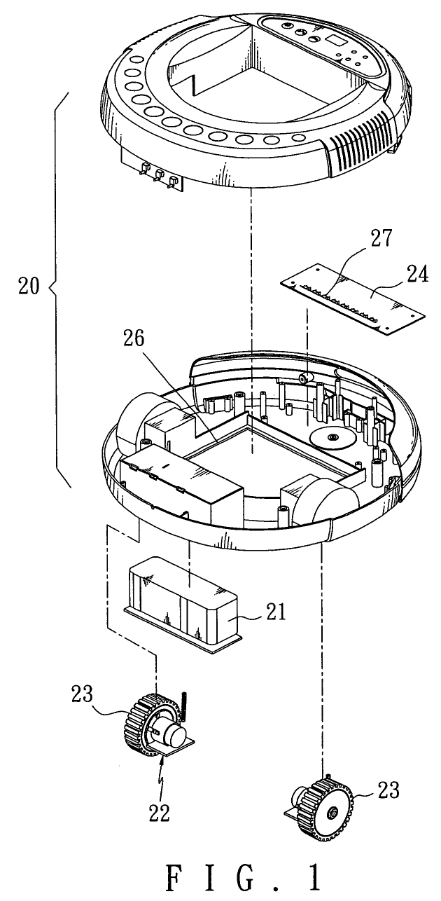

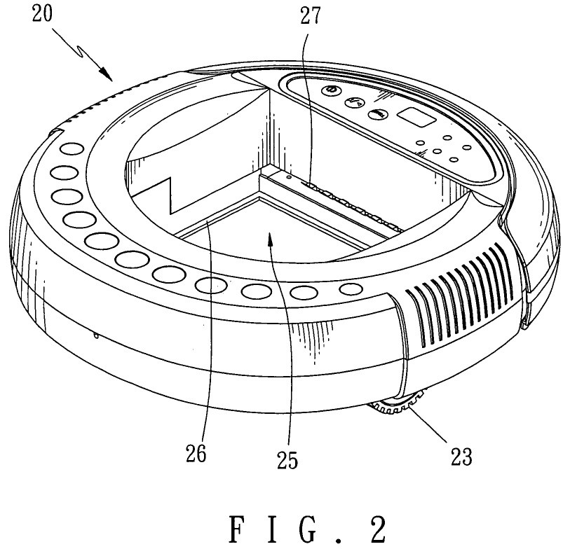

Referring to FIGS. 1 and 2, a robot platform provided with a changeable/expandable module in accordance with a preferred embodiment of the present invention is shown and comprises a base 20 provided in the interior thereof with a power source 21, a drive mechanism 22, a plurality of wheels 23, and a control unit 24. The base 20 can be controlled by the control unit 24 to move on a plain surface in a predetermined motion mode, wherein the structures of the power source 21, the drive mechanism 22 and the wheels 23 have been disclosed in prior art patent applications, hence a detailed description thereof is omitted herein for the sake of brevity. Likewise, the motion modes of base 20 is controlled by the control unit 24, e.g., an avoidable motion resulting from suffering an obstacle, forward movement in a predetermined line, or another avoidable motion resulting form a false step detection etc., are all a well known skill, thus further remarks thereof are omitted as well.

The characteristic of the present invention contains: the base 20, through which a chamber 25 passes, being used to receive a module, and around the periphery of the chamber 25 being formed at least one connecting portion 26. Furthermore, the base 20 is defined with a plurality of conducting and signaling points 27 therein which is coupled to the control unit 24.

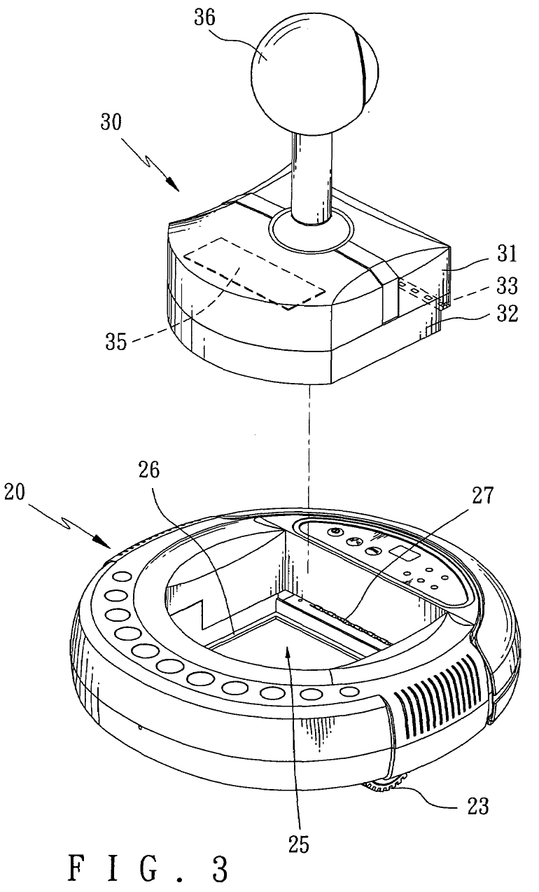

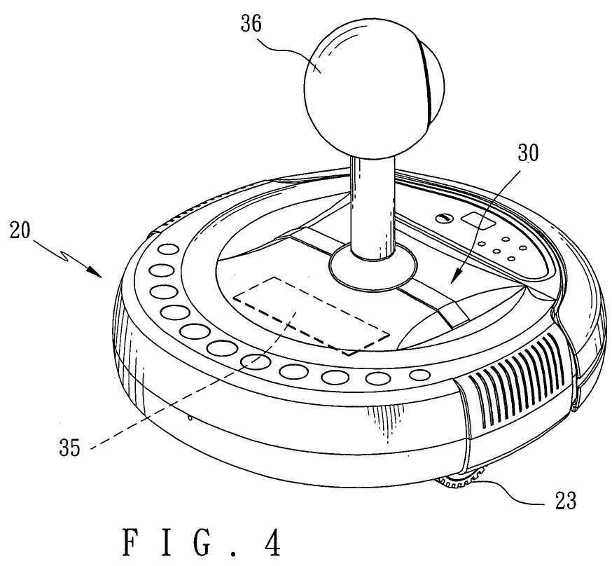

As shown in FIGS. 3-4, a module 30 applied to the above-mentioned robot platform in accordance with a first embodiment of the present invention comprises a body 31 having an insertion portion 32 and a number of contact points 33, the bottom surface of the insertion portion 32 is in response to the connecting portion 26 of the base 20, the body 31 is inserted into the chamber 25 by way of the insertion portion 32, and the contact points 33 correspondingly contacts with the conducting and signaling points 27 such that the electricity and signals of the robot platform can transmit to the module 30. Furthermore, the module 30 is also provided with a main controlling unit 35 and a processing unit 36. The main controlling unit 35 is connected to the contact points 33 for receiving the instruction from a control panel or a wireless device, and for commanding the control unit of the base 20 to actuate the base's movement, simultaneously, the main controlling unit 35 controls the processing unit 36 to execute its instruction, such that the base 20 can cooperate with the processing unit 36 to cause a requested motion. The processing unit 36 can be various types of devices for use in different jobs, such as a vacuum device, an infrared alarm device, an auxiliary device mounted onto a robot arm, a detection device, and so on.

While desiring to replace the module 30, the user merely has to remove the module 30 from the base 20, and then to place another module into the chamber 25 such that the same electricity and signal connection as above-mentioned description can be obtained for providing a corresponding control and power source.

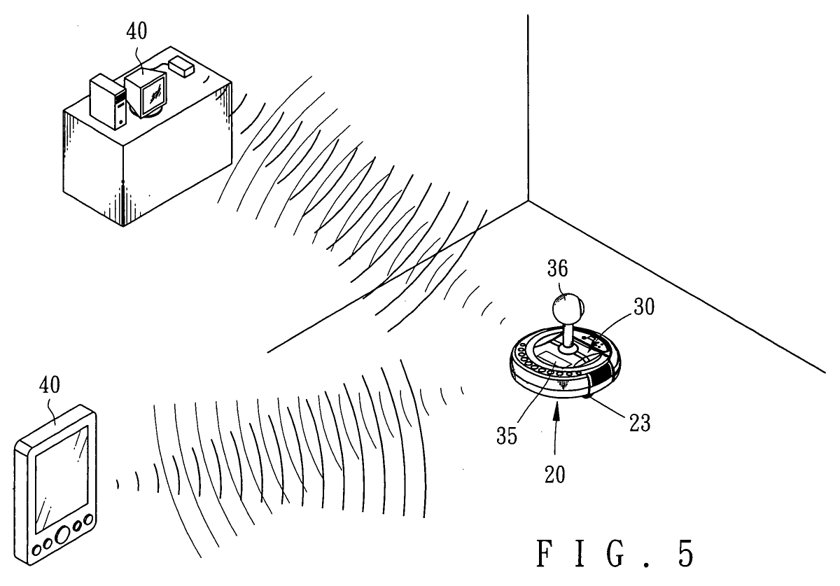

Referring next to FIG. 5, if the module 30 is disposed in the base 20 for use in the detection device, the main controlling unit 35 is applied to receive instructions from a remote monitor terminal 40, and commands the control unit of the base 20 to actuate the base's movement for the cooperation with a processing unit 36 of a video camera to execute a shooting job. The processing unit 36 transmits shooting images to the main controlling unit 35, and then the images will be further transmitted to the remote monitor terminal 40 through the main controlling unit 35, thereby achieving an instant detecting purpose.

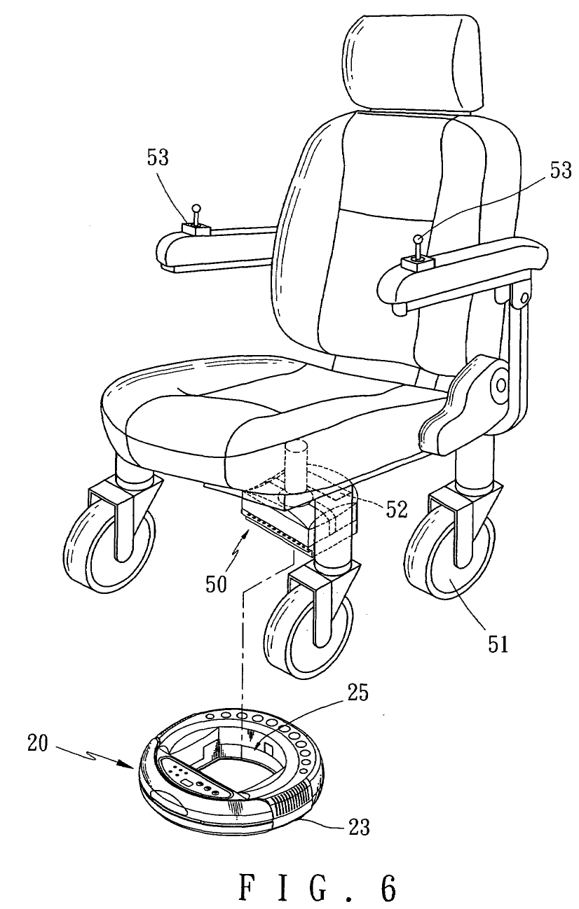

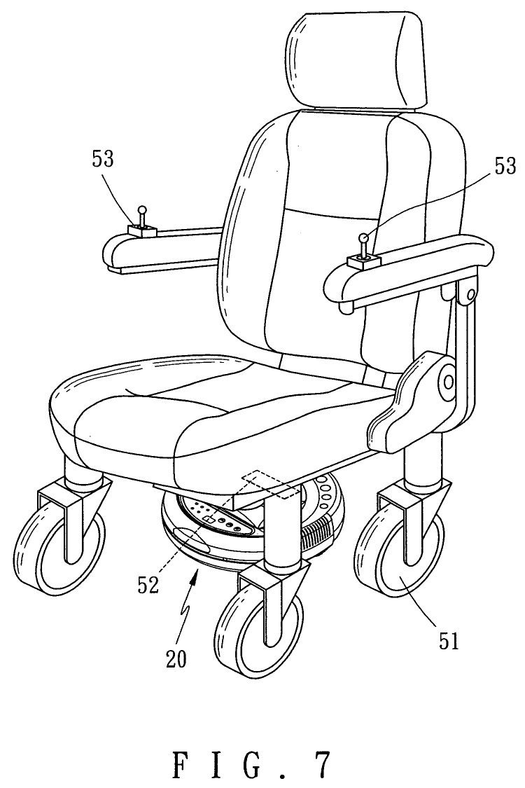

As shown in FIGS. 6 and 7, a module 50 adopted for a wheelchair in accordance with a second embodiment of the present invention comprises the base 20 serving to receive the module 50 such that a plurality of wheels 51 and the wheels 23 thereof flushly contact against the ground, and the main controlling unit 52 of the module 50 receives the instruction from the processing unit 53 of the wheelchair, then commands the control unit of the base 20 to cause the base's movement, hence the wheelchair equipped with the module 50 can be actuated to move.

While we have shown and described various embodiments in accordance with the present invention, it should be clear to those skilled in the art that further embodiments may be made without departing from the scope of the present invention.

What is claimed is:

1. A robot platform provided with a changeable/expandable module comprising:
a base provided in the interior thereof with a power source, a drive mechanism, a plurality of wheels and a control unit, said base can be controlled by said control unit to move on a plain surface in a predetermined motion mode; the characteristic of the present invention including: said base defined with a chamber for receiving a module, and a plurality of conducting and signaling points therein which is coupled to said control unit, said conducting and signaling points severing to contact with contact points on said module to cause an electricity conduction.

2. The robot platform provided with a changeable/expandable module as claimed in claim 1, wherein said chamber vertically passes through said base.

3. The robot platform provided with a changeable/expandable module as claimed in claim 1, wherein around the periphery of said chamber is formed at least one connecting portion.

4. A robot platform provided with a changeable/expandable module comprising:
a body having an insertion portion and a number of contact points, being inserted into a chamber of a base by way of said insertion portion, and said contact points correspondingly contacting with a plurality of conducting and signaling points;
a main controlling unit being connected to said contact points for receiving the instruction, and for commanding a control unit of said base to actuate the base's movement;
a processing unit being controlled by said main controlling unit to execute instruction;

5. The robot platform provided with a changeable/expandable module as claimed in claim 4, wherein said main controlling unit is applied to receive instructions from a remote monitor terminal, and to command said processing unit to execute its instruction.

6. The robot platform provided with a changeable/expandable module as claimed in claim 4, wherein said processing unit of a module can transmit processing result to said remote monitor terminal through said main controlling unit.
